(19) United States
(12) Patent Application Publication
(10) Pub. No.: US 2005/0050734 A1
(43) Pub. Date: Mar. 10, 2005

(54) Snap knife with improved safety and usability

(76) Inventor: Donald A. Kesinger, Littleton, CO (US)

Correspondence Address: THOMAS W. HANSON, LLC, 3990 S. CHEROKEE ST., ENGLEWOOD, CO, 80110, US

(21) Appl. No.: 10/935,047

(22) Filed: Sep. 7, 2004

Related U.S. Application Data
(60) Provisional application No. 60/501,204, filed on Sep. 8, 2003.
(60) Provisional application No. 60/579,865, filed on Jun. 14, 2004.

(51) Int. Cl. B26B 1/08

(52) U.S. Cl. 30/162; 30/335

(57) ABSTRACT

A utility knife using segmented, snap-off blades, or snap knife, incorporating an improved means for snapping off the dull segments. A two part handle is pivotally interconnected so that when closed, a standard handle is formed. When open, the two parts of the handle are aligned opposite each other. The blade, contained in one part can be advanced to enter a slot in the other part. With the segment line of the blade aligned in the gap between the two parts, the blade can be snapped by closing the handles. The snapped segment is preferably retained within the handle for later disposal.

### CROSS-REFERENCE TO RELATED APPLICATIONS

This application claims the benefit of U.S. Provisional Application No. 60/501,204 filed Sep. 8, 2003 and of provisional application 60/579,865 filed Jun. 15, 2004.

### STATEMENT REGARDING FEDERALLY SPONSORED RESEARCH OR DEVELOPMENT

Not Applicable

### BACKGROUND OF THE INVENTION

1. Field of the invention

The present invention relates to the field of utility knives and specifically to such knives as use a segmented blade from which dull segmented can be broken off.

2. Background Information

Utility knives in their many forms are well known in the art. They are used by a wide variety of trades people, and others, on a daily basis. Utilizing disposable blades, they offer an easy method of having a sharp knife readily available without the need to stop for sharpening.

“Snap knives”, or utility knives which use a segmented blade from which segments are snapped off, and disposed of, as they become dull are also well known in the art. It is generally quicker to get a “new” cutting edge with a snap knife than a conventional utility knife as the blade does not need to be removed and replace (or reversed). Instead the blade is merely advanced beyond the end of the knife and the dull segment snapped off. The newly exposed segment is positioned for use and work continues.

Snap knives also suffer disadvantages relative to standard utility knives. These are associated with the removed segment and the method of snapping it from the blade. While considered dull by the user, these segments still retain a sharp edge and point.

The typical methods of snapping off a dull segment pose a risk to the user. This risk comes from the need to handle the bade and removed segment, both of which are sharp, and from the tendency for the snapped segment to fly away as a result of the snapping operation.

The most basic method of snapping a segment is to advance the blade until a segment line is positioned just beyond the end of the knife handle. The end of the blade is placed against a flat surface, with the scored segment line toward the surface, and pressure applied to knife handle, pressing the end of the blade against the surface, flexing the blade at the segment line, and causing the blade to snap at the segment line. As is readily apparent, when the blade snaps, it releases a significant amount of energy which typically results in the freed segment being projected away at high speed. Clearly, a flying blade segment with a sharpened edge poses a risk to both the user and those in the vicinity. There is also significant risk of damage to the surface used for the snapping operation, both from the end of the blade and from the handle of the knife after the blade snaps.

Alternate methods of snapping a segment utilize some type of tool, often having a notch which fits the end of the blade, to snap the dull segment. These reduce the likelihood of the segment flying free, but often leave the cutting edge of the segment exposed to the user's fingers during the operation. The segment must then be handled to remove it from the tool and discard it.

The removed segments still retain a relatively sharp edge and tip. As such they pose a hazard if not disposed of properly, Unfortunately it is common practice to leave them littering the floor of the work place, intentionally or unintentionally. Because of their small size, flat shape, and tendency to be projected outward, blade segments become lost easily. Even if found, they are hazardous to pick up due to their sharp edge and tip. The result is that even the best intentioned user usually leaves a few segments behind. A group of less well intentioned users can leave behind dozens, or even hundreds of segments scattered across a job site.

Alternate methods of snapping and disposing of segments are known. These typically include some type of container with a slot for the blade. The end of the blade is inserted into the slot, the segment snapped by angling the knife to one side, and the segment falls into the container. In some configurations, these devices are incorporated into a holster or other means for the user to carry them. While effective, these devices can be inconvenient to use. They are attached to a belt, or positioned nearby which means that the user must stop work, move the knife away from the work area, snap the blade, and then return the knife to the working position. In some situations, this burden may be minimal. In others, such working in physically restrictive area, such as the crawl space under a house, or on top of a ladder, this burden may be sufficiently excessive to cause the user to forego the use of the container return to simpler methods and let the segment fall.

A further problem with the slotted container approach is that the blade must be inserted into the slot. The segment to be removed is relatively small and the slot, of necessity, is a close fit to the blade. This requires a relatively high degree of precision to fit the blade into the slot. Not a significant problem if working at a bench in a well lighted shop, but a major challenge in low light situations, cramped quarters (especially where the container may not be in line of sight), or where the user is unstable or moving. Again, these difficulties may cause the user to bypass the safe method and revert to snapping and discarding segments using whatever method is available.

There is a need for an improved snap knife which allows used segments to be safely snapped off and discarded. This improved knife should incorporate a snapping mechanism as an integral part of the tool so that it does not become lost and so that it can be used with the knife in or near its working position. This mechanism should be self aligning with the blade to eliminate the difficulties encountered with inserting a blade into a separate slot. The snapping mechanism should retain the freed segment so that it can not fly free. Ideally, a container should be incorporated so that the blade segments can be stored until such time as they can be properly disposed of.

### BRIEF SUMMARY OF THE INVENTION

The present invention is directed to a utility knife for use with segmented, snap-off blades which incorporates an integral mechanism for snapping the blade segments. It preferably also incorporates a disposal container to retain the snapped segments for later disposal.

According to the invention there is provided a two part handle, pivotally interconnected. The blade is contained within a first part, and is extendable outward through a blade slot for normal use or for snapping. The second part has a second slot for receiving the end of the blade. This opening is automatically aligned with the blade slot when the handles are opened outward completely. The blade can be advanced so that the end enters the second slot and can be snapped by closing the handles.

According to an aspect of the invention the ends of the two handle parts are angled so that when fully opened they are parallel to each other and to the segment lines on the blade.

According to another aspect of the invention the second handle part incorporates a disposal chamber for receiving and retaining the removed segments for later disposal, This chamber may be either defined by the handle part or may be a separate removable, and optionally disposable, cartridge. Where a disposal chamber is provided, the second slot serves to feed segments into it and the slot is sealed by the opposing handle part when the handles are closed.

Further in accordance with the invention storage for additional unused blades may also be provided either in the same chamber as the removed segments, or in a separate chamber. this chamber would be closable in some manner to retain the blades and segments. The cap used to close the chamber may also comprise means to hold the spare blades, preferably positioning them to one side to reduce interference with or from the segments.

The advantages of such an apparatus are increased safety and usability. A dull segments can be quickly snapped off the blade without the user ever being required to touch the blade or to move the knife any significant distance from its working position. The process merely involves retracting the blade, opening the handles, advancing the blade into the second slot, and closing the handles. That done, the blade has been snapped and work can process.

The above and other features and advantages of the present invention will become more clear from the detailed description of a specific illustrative embodiment thereof, presented below in conjunction with the accompanying drawings.

### BRIEF DESCRIPTION OF THE SEVERAL VIEWS OF THE DRAWINGS

FIG. 1 is a perspective view of a snap knife according to the preferred embodiment of the present invention, with a blade in position for cutting, showing the front face.

FIG. 2 is a perspective view of a snap knife according to the preferred embodiment of the present invention, with a blade in position for cutting, showing the reverse face.

FIG. 3 is a view from the front with the knife closed.

FIG. 4 is a cross section through the knife along the line shown in FIG. 3.

FIG. 5 is a top view of the knife.

FIG. 6 is a front view of the knife fully opened, with the blade positioned for snapping.

FIG. 7 is a detail view of the joint region of the knife, in the open position, with the blade positioned for snapping.

FIG. 8 is a bottom view of the knife in the open position.

FIG. 9 is a cross section through the knife in the open position, in the same plane as FIG. 4.

FIG. 10 is a detail view of FIG. 9 showing the relative alignment of the two parts of the handle, the blade slot, the breaking slot, and the blade.

FIG. 11 is a cross section through the knife, after snapping a segment from the blade, in the same plane as FIG. 4.

FIG. 12 is a detail view of FIG. 11 illustrating the disposition of the removed segment.

FIG. 13 is an exploded view of a snap knife according to the preferred embodiment of the present invention illustrating the various parts.

FIG. 14 is a perspective view of a sub-assembly of the preferred embodiment comprising the inner handle and follower with a blade in position for cutting.

FIG. 15 is a perspective view of the inner handle.

FIG. 16 is a perspective view of the outer handle.

FIG. 17 shows an alternative embodiment of the outer handle having a tapered disposal chamber FIG. 18 is a cross section through the outer handle of FIG. 17.

FIG. 19 is a side view of an alternative embodiment of the outer handle part with disposable cartridge in place.

FIG. 20 is a perspective view of the disposable cartridge.

FIG. 21 is a side view of an embodiment of the end cap having a slot to hold the spare blades.

FIG. 22 is a perspective view of an alternative embodiment which uses simple, non-nesting handle parts and a closed disposal chamber.

### DETAILED DESCRIPTION OF THE INVENTION

The following discussion focuses on the preferred embodiment of the invention, a snap knife configured for use much like a conventional utility knife. However, as will be recognized by those skilled in the art, the disclosed method and apparatus are applicable to a wide variety of situations in which safe and easy snapping of segments from a cutting tool which uses a segmented blade is desired.

Glossary

The following is a brief glossary of terms used herein. The supplied definitions are applicable throughout this specification and the claims unless the term is clearly used in another manner.

Closed, Open—relative positions of the two parts of the handle. The Closed position is when the inner handle is nested within the outer handle and the knife is usable for cutting. The Open position is when the inner and outer handles are positioned opposite each other, in position for snapping a blade segment.

Inner, Outer—directions which when used relative to the two parts of the handle, are defined with the handle in its closed position. Inner is then toward the interior of the combined handle and Outer is toward the exterior. Consistent with this, Inner is toward the enclosed angle through which the two parts of the handle move when pivoting.

Segmentation Lines—scored line in blade which proved a weakened path along which the blade will snap relatively easily

Snap Knife—generally any knife which utilizes a segmented blade, allowing the end segment to be snapped off when it becomes dull, exposing a new, sharp segment.

### PREFERRED EMBODIMENT

The disclosed invention is described below with reference to the accompanying figures in which like reference numbers designate like parts. Generally, numbers in the 200's refer to prior art elements or elements in the surrounding environment while numbers in the 100's refer to elements of the invention. Note that the blade illustrated in the figures, and described below, is not a part of the invention itself.

Overview

The present invention is a snap-knife with significantly improved usability and safety. These both result primarily by the provision of a means of snapping off blade segments which eliminates all need for the user to touch the blade during or after the operation. The handle is simply opened outward to the fully extended position, the blade extended to enter the breaking slot in the opposite part of the handle, and the handles closed again, The pivoting motion of the handles as they close snaps off the blade and the removed segment is retained within the enclosed cavity of the handle. All risk of injury or damage from flying or discarded blade segments is eliminated. The risk of damage to a surface caused by pressing the blade against it to snap the blade, as is commonly done, is also eliminated.

The process of snapping a blade segment is much easier than with conventional knives because no separate tool is needed and the breaking slot incorporated into the handle automatically aligns with the blade when the handle is opened out.

Structure

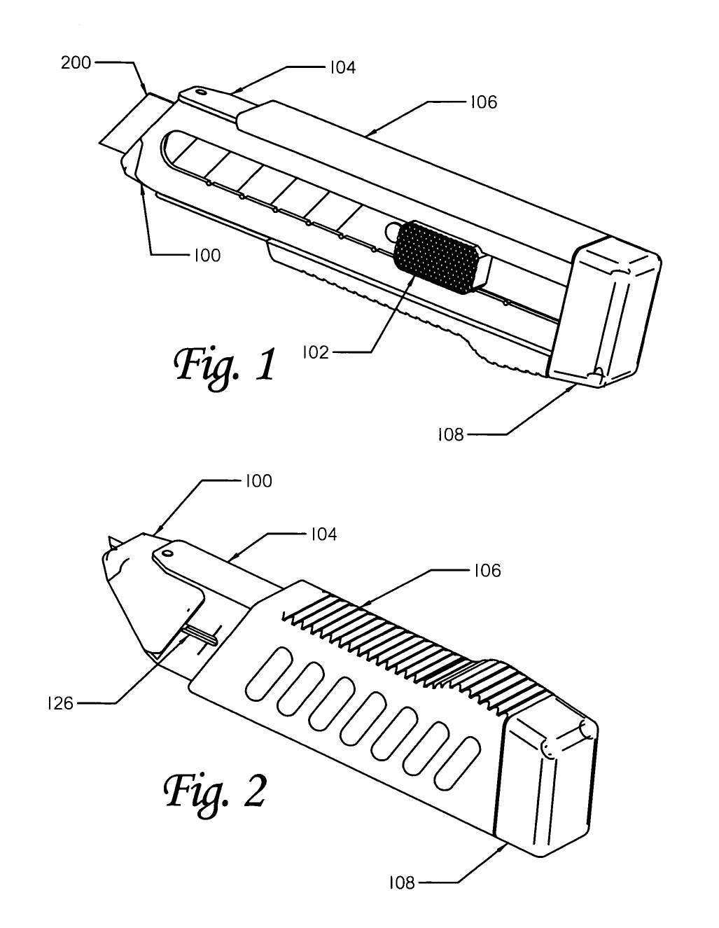

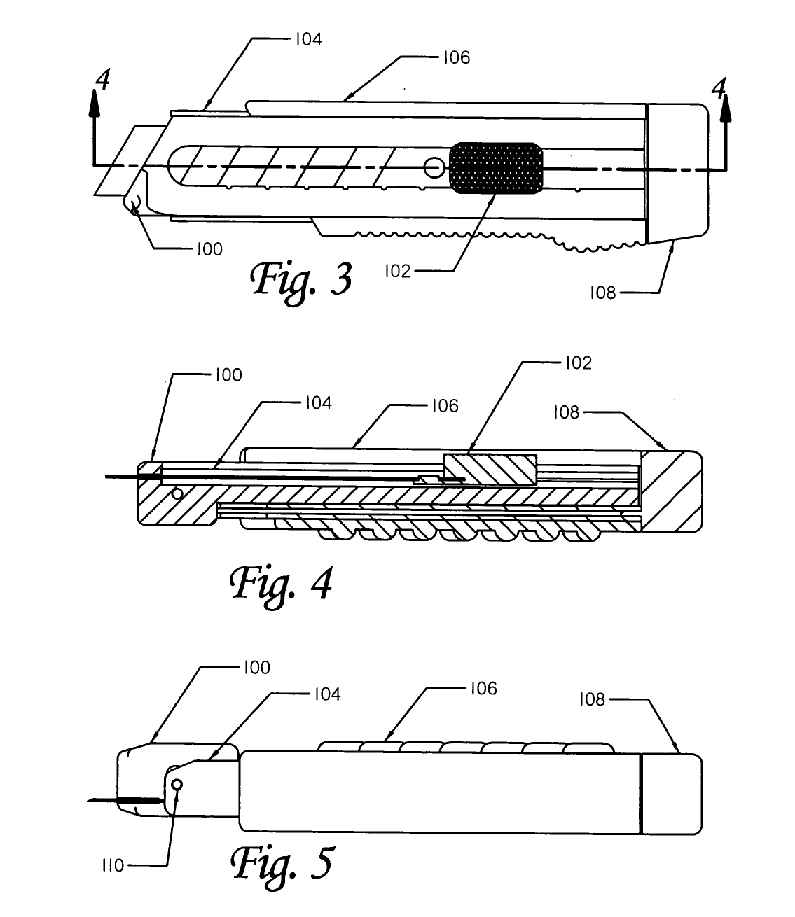

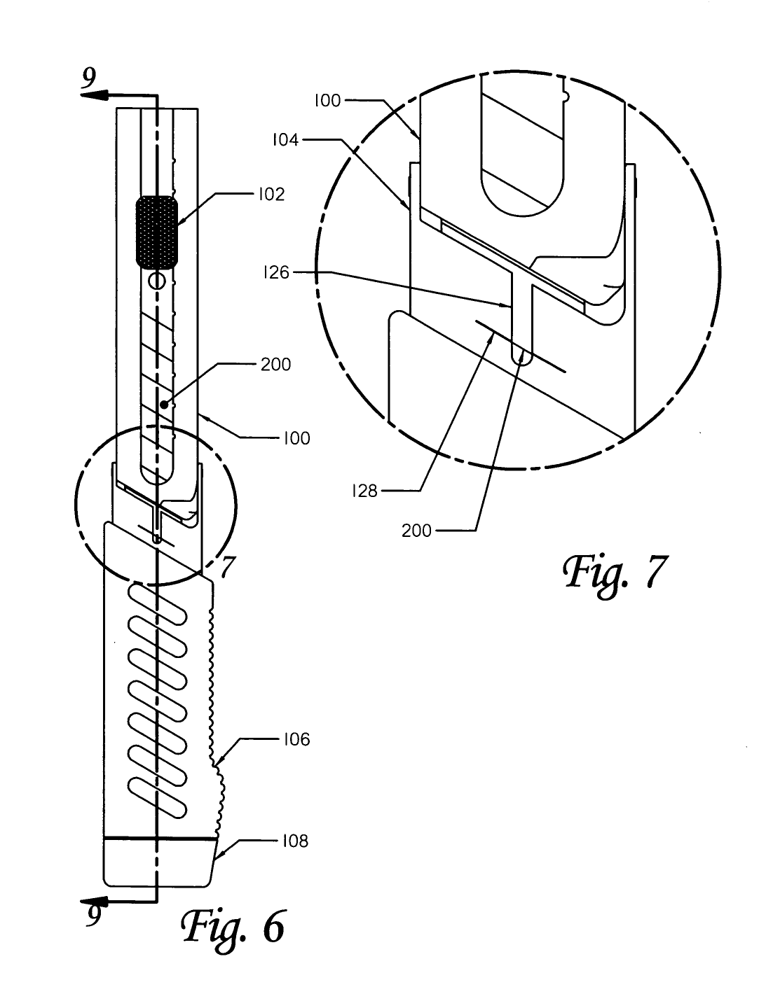

The basic structure of the present invention is that of a two part handle having an inner part, 100, and an outer part, 104, pivotally connected. The two parts of the handle can pivot relative to each other between a closed and an open position. In the closed position, illustrated in FIGS. 1 & 2, the inner part nests within the outer part and the combination forms a shape much like that of a conventional utility knife and the inventive knife can be used in much the same manner. In the open position, illustrated in FIGS. 6 & 8, the two parts are substantially aligned with each other, but in opposition about the pivot pin, 110. This is the position in which the two halves cooperate to snap a segment off of the knife blade. The configuration of the preferred embodiment, which provide two full length handles offers significant leverage to perform the snapping operation,

The inner part of the handle, 100, is structured much like a conventional snap knife and in cooperation with the follower, 102, and the blade, 200, functions in much the same manner. Referring to FIG. 14, it can be seen that the blade is received within a channel, 136, in the handle where it is free to move longitudinally. The blade follower has a protrusion, 114, which engages a matching hole in the blade. The blade is retained and positioned by the follower within the channel. The follower is adapted to slide within the same channel as the blade, with a portion extending out through the guide slot, 116, and engaging the edges of the slot. Preferably, the follower also incorporates a detent mechanism which engages the detents, 118, defined in at least one edge of the guide slot. This allows the follower, and attached blade, to be positioned to and retained in discrete positions relative to the handle. A variety of other means to advance and retract the blade are known and would also be applicable.

With the blade and follower engaged as described above and both positioned within the channel, the parts function as a conventional snap knife as is well known in the industry. The follower and blade may be retracted within the handle, guarding the blade, or extended to expose a portion of the blade so that it may be used for cutting, scoring, or other operations. When the blade is extended to the point that one of the segment lines is exposed, a segment of the blade may be snapped off in a conventional manner. The blade extends through a blade slot, 124, in the end of the handle which preferably closely receives the blade, providing support for cutting and snapping operations. Preferably, at least a portion of the edge of this opening is aligned parallel to the segment lines in the blade to ease snapping off a segment.

It is when the above assembly of inner handle part, blade, and follower are combined with the outer part of the handle the benefits of the present invention are realized. The raised portion, 112, of the inner part of the handle is specifically designed to work in combination with the outer portion of the handle. Its primary purpose is to block the breaking slot (described below) in the outer part of the handle, so that blades and blade segments can not accidentally slide out of the breaking slot. This raised portion also provides increased material thickness about the pivot point and provides a smooth transition between the outer part of the handle and the inner part.

Referring to FIG. 15, the configuration of the outer part, 104, of the handle can be clearly seen. The outer part defines a substantially C-shaped channel which is adapted to receive the inner part of the handle. It also defines a disposal cavity, 120, which is adapted to hold discarded blade segments. Optionally, it can also hold spare blades. The disposal cavity has an opening, 122, which communicates with the exterior of the handle. This opening, or breaking slot, serves primarily to receive the segment, or segments, at end of the blade which are to be removed and to apply force to them to effect the snapping operation. Optional viewing slot, 126, and registration marks, 128, assist in proper alignment of the blade for snapping off the last segment.

As shown in FIGS. 9 & 10, the blade slot, 124, in the end of the inner handle, through which the blade extends, and the breaking slot, 122, in the outer handle, are adapted to be substantially in alignment when the handle is in its open position. This allows the blade to enter the breaking slot as it is extended out of the inner handle. The lips of the blade slot and of the breaking slot are adapted to be substantially parallel and in close proximity with the handle open. They are angled to be substantially parallel to the segment lines in the blade. This arrangement allows the lips to apply force to the blade on either side of a segment line during the snapping operation, described below. The breaking slot is preferably sized to closely receive the end of the blade, but this is not essential. A larger opening will still function effectively, but may require a greater range of handle movement before the blade snaps.

Ideally, the lips of the breaking slot will be arranged at a slight angle to the plane of the blade, such that the lip contacts the blade at the spine slightly before contacting the cutting edge. This has been found to provide a cleaner break of the blade than other configurations.

The breaking slot preferably communicates with the disposal cavity. This cavity fully encloses the end segment(s) of the blade throughout the snapping operation and afterward. This eliminates any risk of the snapped segment(s) from being thrown outward, or falling free, significantly reducing risk of injury or damage. It should be noted that while only a single segment is typically snapped off, the present invention as also adapted to remove multiple segments safely, with a single operation. This might be necessary where the blade has been used to cut thick materials, dulling more than one segment. In a conventional snap knife, this would require multiple snapping operations, removing each segment individually. With the present invention, the blade is simply extended until the desired segment line is properly aligned, and all segments are removed with a single snap.

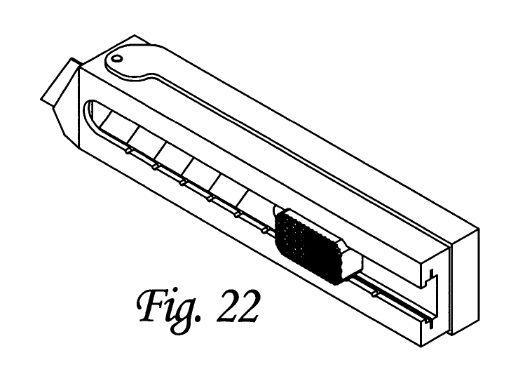

In the preferred embodiment, the butt end of the disposal cavity opposite the breaking slot is also open to allow removal of segments which have been snapped off and to allow insertion of spare blades. This opening is blocked by an end cap, 108, to retain the segments and blades while the knife is in use. Preferably this cap is retained by an integral plug which fits into the end of the cavity. Optionally, it could be hinged or pivotally attached to the outer handle. An advantage to the plug retention method is that the end cap can also grip the spare blades, such as by inserting the blades into slot 130 FIG. 21, allowing them to be removed from the cavity without the risk of the discarded segments also falling out. As illustrated, the slot can be angled so that the spare blades are held against one side of the cavity, allowing more space for the segments. If preferred, the butt end could be closed, see FIG. 22, with blade segments being removed through the breaking slot.

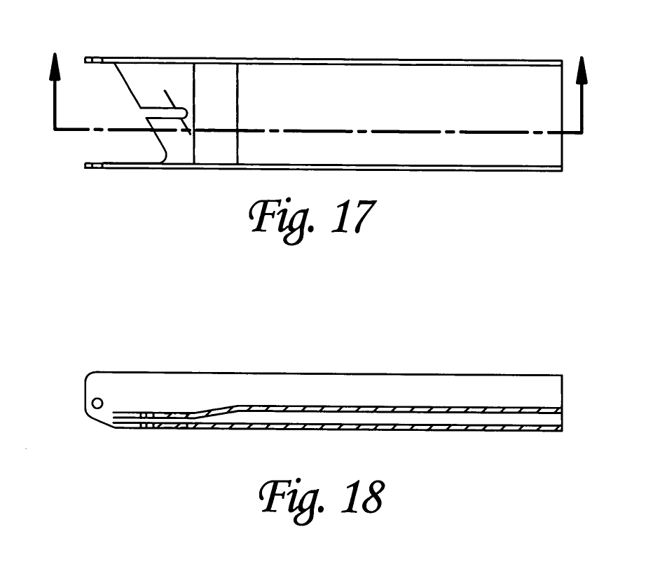

In the generally illustrated embodiment of the present invention, the disposal cavity within the outer handle is shown as having a constant cross section along its length, with the breaking slot having the same profile. This offers the simplest manufacture, as the part can be formed by continuous extrusion, but also provides minimal capacity for blade segments. In the alternate embodiment of FIGS. 17 & 18, the cavity has a larger profile with the sides tapering together to form the lips of the breaking slot. This is the preferred embodiment for functionality, but is more complicated to manufacture.

Further improved functionality is provided if the chamber tapers continually to its widest point at the capped end. This reduces the chances of segments jamming within the chamber. It is also preferred that the width of the disposal chamber be greater that the largest dimension of a blade segment. Generally, this dimension is the longest of the two diagonals across the face. With the disposal chamber wider than this, a single segment can not become jammed within the chamber.

Clearly, the disposal cavity could be eliminated altogether, or left open so that the segments fall free. This would be applicable where a separate container, specific to the purpose or for general rubbish, is provided nearby into which the segments can be allowed to fall. One example of such a situation is where the knife is to be used at a fixed workstation having a disposal slot or container. If large numbers of segments are removed during a work shift, they may exceed the capacity of the disposal cavity. It may be more efficient to then discard the segments immediately after removal. Either an open ended cavity, where the segments fall through, or a closed cavity, where they are dumped back out through the breaking slot would be effective. The preferred configuration with the end cap removed or eliminated would suffice.

The grip, 106, is optional. While improving the comfort and usability of the knife, it does not effect the functionality in any significant manner and is not essential to the present invention. In the preferred embodiment, the grip is formed by over-molding a polymer material on the exterior of the outer handle. It could also be made as a press-on part and could be made from a variety of materials as is known in the art.

Operation

For cutting, a knife according to the present invention is used much like a conventional snap knife. The handle is placed in its closed position and the blade extended out through the blade slot to the extent necessary for the cutting task, see FIG. 1. Upon completion of the task, the blade is retracted into the handle so that the cutting edge is guarded.

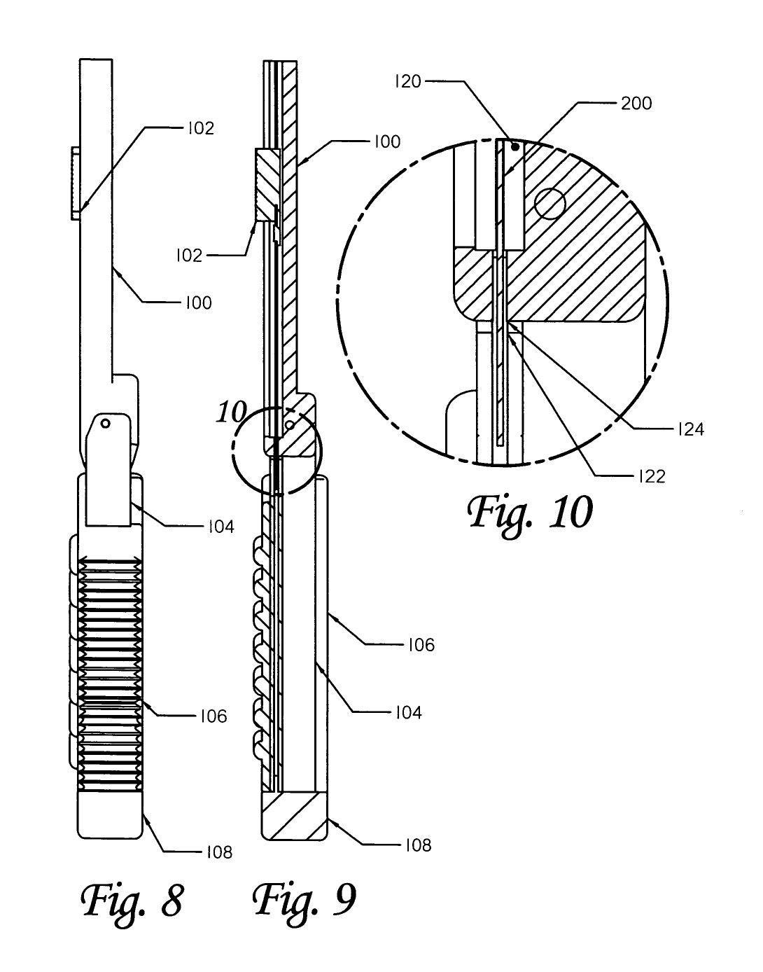

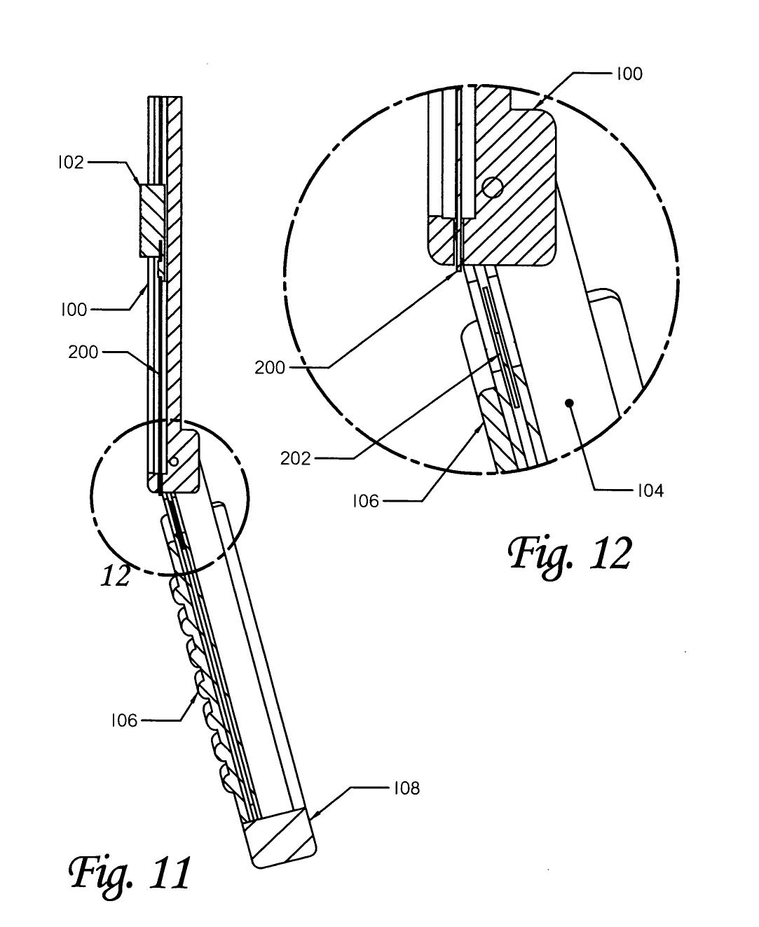

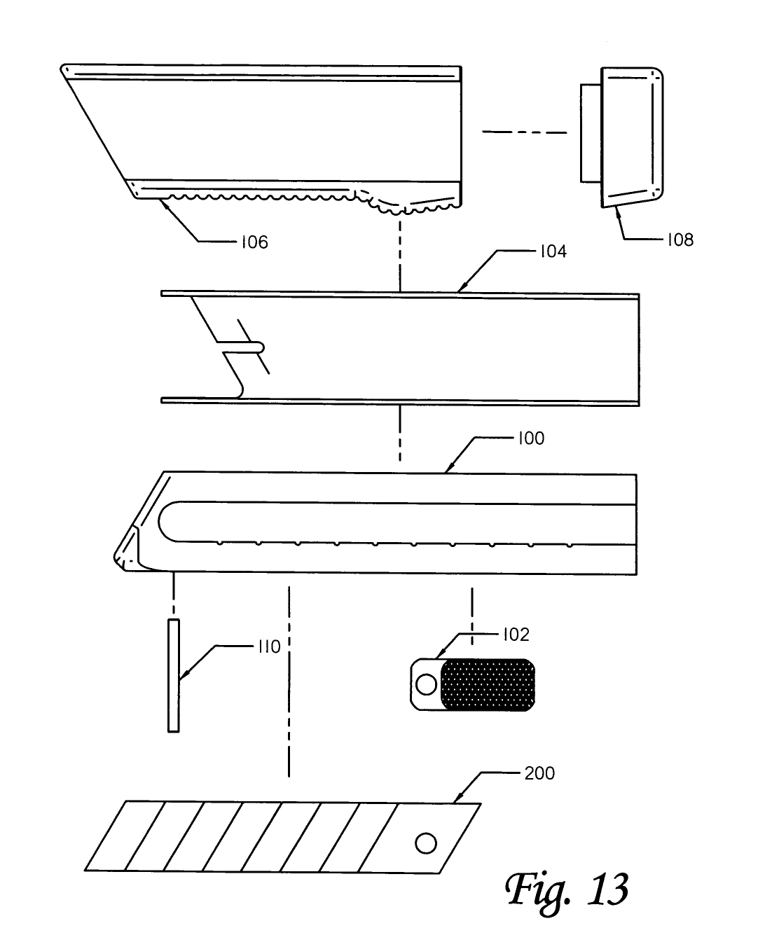

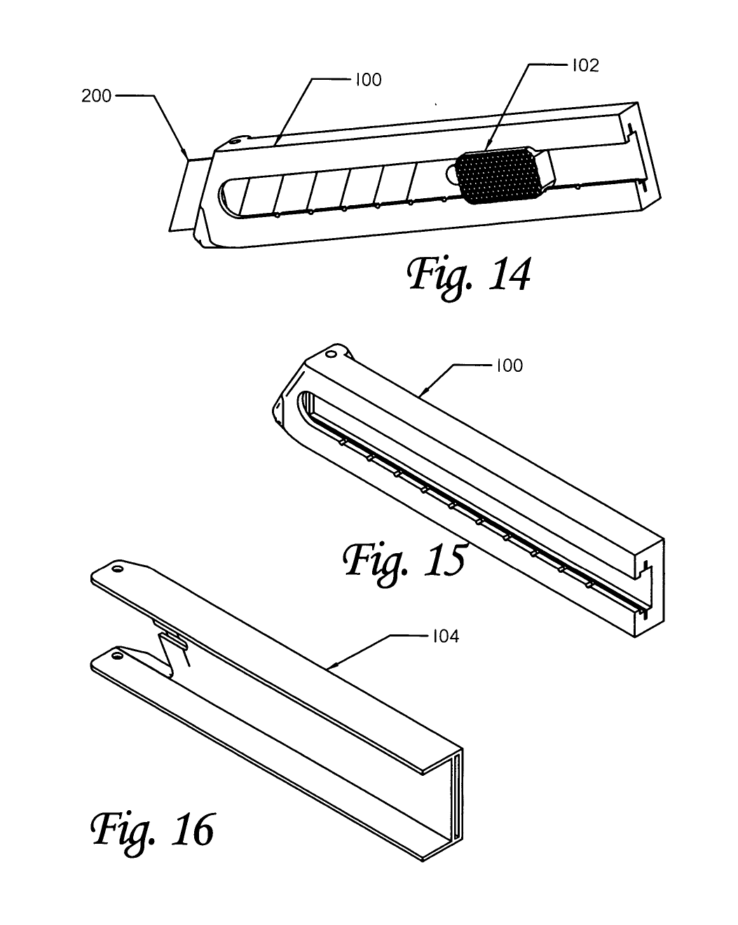

To snap a blade, the handle should be closed as in FIG. 1 and the blade should be retracted into the handle. The inner and outer parts of the handle are opened out to the position shown in FIGS. 6 and 8. The blade, 200, is then extended through the blade slot, 124, and into the breaking slot, 122. The position of the blade is adjusted so that the segment line, 204, is positioned in the gap between the blade slot and the breaking slot. This may be done by visually aligning the segment line with the slot or by aligning the end of the blade with the optional registration marks, 128, adjacent the viewing slot. The advantage of the registration marks is that they can be placed on both inner and outer sides of the outer handle so that they are visible from both sides. The segment line on the blade is only visible from one side. With the blade in position, the handles are folded inward toward a position such as that illustrated in FIG. 11. This causes the blade slot and breaking slot to apply a bending force to the blade on either side of the aligned segment line causing the blade to snap at the segment line. The result is as shown in FIGS. 11 & 12. The end segment, 202, breaks off and is retained within the breaking slot. If the knife is held with the outer handle downward, the segment will fall into the disposal cavity. Otherwise, the knife can be tilted so that this occurs. The handles are then completely closed and the knife is again ready for use with the user having never handled the removed blade segment. In the closed position, the raised portion, 112, of the inner part of the handle blocks the breaking slot in the outer part of the handle, retaining the blade segment(s) within the cavity.

Materials

A variety of materials are suitable for a snap knife made according to the present invention. Both metals and plastics are suitable for most of the parts, with plastics such as glass filled nylon offering light weight, durability, and simple manufacturing.

The most highly stressed portion of the knife will likely be the lips of the breaking slot and possibly those of the blade slot. For durability and wear, these parts should probably be made of metal. This can be accomplished in a variety of well known ways including making the entire inner and outer handle parts of metal; making separate end pieces of metal, attached to plastic bodies; inserting metal lips into a plastics body; etc.

### ALTERNATIVE EMBODIMENTS

The following discussion presents alternative embodiments which offer various advantages in structure or functions without departing from the principles of the invention.

If desired, a detent mechanism can be added to hold the handle parts in their closed position. An option to hold them in the open position is also anticipated. A clear candidate for the detent mechanism is a spring loaded ball in one part of the handle which engages a recess in the other part. Other approaches could also be used as is well known in the art.

While the preferred embodiment utilizes a one piece outer handle, this is not a requirement. An alternative is to form the nose of the handle, including the breaking slot, and the main body of the outer handle as separate pieces and then join them together. This has the advantage of allowing different materials, such as a hardened metal for the nose, which would provide long-wearing lips for the breaking slot, and injection molded or extruded plastic for the main body. A similar approach could also be taken for the inner part of the handle.

The preferred embodiment utilizes a single compartment to hold both the blade segments which have been snapped off, and the new blades. If desired, two separate cavities could be used. This would offer the advantage of protecting the cutting edges of the new blades from being nicked by the blade segments.

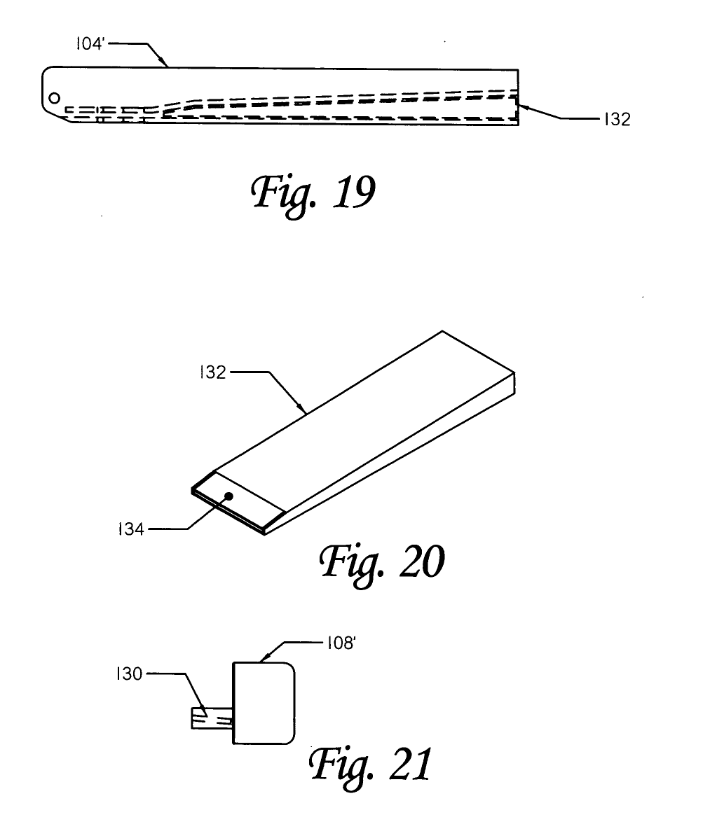

For additional safety, the snap knife can be fitted with a disposable cartridge to hold the removed blade segments. See FIGS. 19 & 20. The cartridge, 132, would fit within the disposal chamber of the outer handle and receive the segments as described above. For disposal, the cartridge would be removed, sealed and discarded. Preferably, it would be sealed by a hinged flap, 134, which can be pressed closed upon removal. The flap would then be held closed by interlocking tabs and notches on the edges of the flap and inner surface of the side walls or similar means. If desired, similar tabs and notches could be used to hold the flap in an open, or partially open position during use. As the cartridge is designed to contain the segments, the disposal chamber is no longer needed. Although a convenient means of retaining the cartridge, it could be eliminated and the cartridge retained in position aligned with the breaking slot using other means such as tabs or latches. As a further alternative, one or more new blades could be provided within the cartridge, to be removed before the cartridge is installed in the knife. Clearly, the cartridge need not be disposable, but could be removable for emptying and re-installed afterward for re-use.

While the preferred embodiment comprises nesting inner and outer handle parts which nest when the handle is closed, this is not necessary. Two parallel handle parts pivotally connected at one end, see FIG. 22, are also functional within the scope of this invention although such a configuration may offer reduced strength and functionality. The core characteristic is that the blade slot in one half align with a breaking slot in the other half when the handle parts are opened, allowing the blade to be extended and snapped by closing the handle parts. It is also anticipated that one of the handle parts could be shorter than the other. For example, that part containing the breaking slot could be significantly shorter without adversely impacting the functionality of the invention.

While the preferred form of the invention has been disclosed above, alternative methods of practicing the invention are readily apparent to the skilled practitioner. The above description of the preferred embodiment is intended to be illustrative only and not to limit the scope of the invention.

1) A snap knife, adapted to use and operate upon a segmented blade, said snap knife comprising:
a) a first handle part defining a blade slot through a first end thereof and defining a channel adapted to slidably receive the blade and, said channel communicating with said blade slot whereby the blade can pass freely from said channel outward through said blade slot;
b) means for advancing the blade along said channel;
c) a second handle part defining a breaking slot in a first end thereof; and
said first and second handle parts pivotally connected and movable between a closed and an open position wherein with said handle parts in said open position, said blade slot substantially aligns with said breaking slot.

2) The snap knife of claim 1 wherein said first end of at least one of said first and second handle parts is angled to be substantially parallel to the segment lines of the blade when in said open position.

3) The snap knife of claim 1 further comprising a disposable cartridge removably attachable to said second handle part and adapted to receive freed blade segments from said breaking slot.

4) The snap knife of claim 1 wherein said second handle part further defines a disposal chamber in communication with said breaking slot.

5) The snap knife of claim of claim 3 wherein said disposal chamber has a width greater than the largest dimension of a single segment of the blade.

6) The snap knife of claim 3 wherein said disposal chamber tapers in at least one dimension, being narrower at the breaking slot end and wider at the opposite end.

7) The snap knife of claim of claim 3 wherein with said handle parts in said closed position, said first handle part blocks access to said breaking slot defined in said second handle part.

8) The snap knife of claim 3 wherein said second handle part further defines a disposal opening communicating between said disposal chamber and the exterior of said handle part.

9) The snap knife of claim 4 further comprising a means for removably blocking said disposal opening.

10) The snap knife of claim 8 wherein said disposal chamber is also adapted to receive spare blades.

11) The snap knife of claim 9 wherein said means for blocking said opening further comprises means for retaining the spare blades.

12) The snap knife of claim 3 wherein at least one of said handle parts defines a storage compartment, in communication with the exterior of the handle part, adapted to receive spare blades.

13) A snap knife, adapted to use and operate upon a segmented blade, said snap knife comprising:
a) an inner handle part defining a blade slot through a first end thereof and defining a channel adapted to slidably receive the blade and, said channel communicating with said blade slot whereby the blade can pass freely from said channel outward through said blade slot;
b) means for advancing the blade along said channel;
c) an outer handle part defining a breaking slot in a first end thereof, defining a disposal chamber in communication with said breaking slot and defining a cavity adapted to receive said inner handle part; and
said first and second handle parts pivotally connected and movable between a closed position wherein said inner handle part is at least partially received by said chamber in said outer handle part and an open position wherein said blade slot substantially aligns with said breaking slot whereby said blade can be advanced to enter said breaking slot.

14) The snap knife of claim 13 wherein said first end of each of said inner and outer handle parts is angled so that with said handle parts are in said open position, said first ends are substantially parallel to each other and parallel to the segment lines of the blade.

15) The snap knife of claim of claim 13 wherein said inner handle part has a raised projection which when said handle are in said closed position blocks access to said breaking slot defined in said second handle part.

16) The snap knife of claim 13 wherein said disposal chamber has an opening communicating with the exterior of said outer handle part and said snap knife further comprises a means for removably blocking said disposal opening.

17) The snap knife of claim 16 wherein said disposal chamber is also adapted to receive spare blades and said means for blocking said opening further comprises means for retaining the spare blades.

18) The snap knife of claim 13 further comprising a disposable cartridge adapted to be received within said disposal chamber and adapted to receive freed blade segments from said breaking slot.

19) The snap knife of claim 13 wherein said outer handle part further defines a viewing slot which allows viewing of at least a portion of the end of the blade when the blade is in position to be snapped.

20) The snap knife of claim 19 wherein said outer handle part further comprises at least one registration mark which provides a visual indication of correct blade position when it is to be snapped.
